(19) United States
(12) Patent Application Publication
(10) Pub. No.: US 2005/0111429 A1
(43) Pub. Date: May 26, 2005

(54) System and method for dynamically allocating resources in a mobile communication system employing orthogonal frequency division multiple access

(75) Inventors: So-Hyun Kim, Suwon-si (KR); Chang-Hoi Koo, Seongnam-si (KR); Jung-Je Son, Seongnam-si (KR); Yeong-Moon Son, Anyang-si (KR); Sung-Jin Lee, Suwon-si (KR); Hyun-Jeong Kang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/945,206

(22) Filed: Sep. 20, 2004

(30) Foreign Application Priority Data
Sep. 20, 2003 (KR) 65422/2003

(51) Int. Cl. H04J 11/00

(52) U.S. Cl. 370/344; 370/468

(57) ABSTRACT

A system and method for dynamically allocating a frame cell (FC) and subchannel (FC/subchannel) is disclosed. An access point receives channel quality information (CQIs) which is fed back from a plurality of access terminals on an FC-by-FC basis, and determines a modulation and coding scheme (MCS) to be applied to each of the access terminals. If access terminals whose FCs/subchannels must be changed are detected from the plurality of the access terminals, the access point sends an FC/subchannel change request for the detected access terminals to an access router. The access router generates weights for all FCs, allocates an FC/subchannel set by selecting a predetermined number of FCs/subchannels considering the weights of the FCs for the access terminals corresponding to the received FC/subchannel change request, and transmits information on the allocated FC/subchannel set to the access point. The access point selects and allocates a particular FC/subchannel from among FCs/subchannels in the FC/subchannel set information received from the access router for the access terminals whose FCs/subchannels must be changed, based on CQIs last received from the access terminals whose FCs/subchannels must be changed.

### PRIORITY

This application claims priority under 35 U.S.C. § 119 to an application entitled “System and Method for Dynamically Allocating Resources in a Mobile Communication System Employing Orthogonal Frequency Division Multiple Access” filed in the Korean Intellectual Property Office on Sep. 20, 2003 and assigned Serial No. 2003-65422, the contents of which are incorporated herein by reference.

### BACKGROUND OF THE INVENTION

1. Field of the Invention

The present invention relates generally to a mobile communication system employing Orthogonal Frequency Division Multiple Access (OFDMA), and more particularly to a system and method for dynamically allocating resources according to channel states.

2. Description of the Related Art

With the introduction of cellular mobile communication systems in the United States in the late 1970's, South Korea started to provide a voice communication services using an Advanced Mobile Phone Service (AMPS) system, which is a first generation (1G) analog mobile communication system. In the mid 1990's, South Korea commercialized a Code Division Multiple Access (CDMA) system, which is a second generation (2G) mobile communication system, to provide voice and low-speed data services.

Since the late 1990's, South Korea has partially deployed an IMT-2000 (International Mobile Telecommunication-2000) system, which is a third generation (3G) mobile communication system, aiming at advanced wireless multimedia service, global roaming, and high-speed data service. The 3G mobile communication system was developed especially to transmit data at high rate in compliance with the rapid increase in amount of data serviced therein.

The current 3G mobile communication system is evolving into a next generation communication system which is known as a fourth generation (4G) mobile communication system. Research is currently being conducted on technology for providing users with services which guarantee desired qualities of service (QoSs) at data rates of about 100 Mbps using the 4G mobile communication system. The current 3G mobile communication system generally supports a data rate of about 384 Kbps in a channel environment having relatively poor conditions (e.g., an outdoor channel environment), and supports a data rate of a maximum of 2 Mbps even in a channel environment having a relatively good channel conditions (e.g., an indoor channel environment).

Because wireless local area network (LAN) systems and wireless metropolitan area network (MAN) systems generally support data rates between 20 and 50 Mbps, research is currently being pursued to develop a new communication system which provides mobility and QoS for the wireless LAN system and the wireless MAN system while yielding a relatively high data rate in order to support a high-speed service which the 4G communication system requires.

When broadband spectrum resources are used to provide the high-speed data, for example, a wireless multimedia service, intersymbol interference (ISI) occurs due to multipath propagation, and the intersymbol interference reduces the entire transmission efficiency of the system. Orthogonal Frequency Division Multiplexing (OFDM) has been proposed to resolve the intersymbol interference problem caused by the multipath propagation. OFDM is a modulation technique for dividing the entire frequency band into a plurality of subcarriers before transmission. The use of OFDM increases one symbol duration, thereby minimizing the intersymbol interference.

OFDM scheme is a special case of Multi-Carrier Modulation in which an input serial symbol stream is converted into parallel symbol streams and then the parallel symbol streams are modulated into multiple orthogonal subcarriers before being transmitted. The first MCM systems appeared in the late 1950's for military high frequency (HF) radio communication, and OFDM scheme with overlapping orthogonal subcarriers was initially developed in the 1970's. In view of orthogonal modulation between multiple carriers, the OFDM scheme has limitations in actual implementation for systems. In 1971, Weinstein, et. al. proved that OFDM modulation/demodulation can be efficiently processed using a Discrete Fourier Transform (DFT), which was a driving force behind the development of OFDM scheme. Also, the introduction of a guard interval and a cyclic prefix as the guard interval further mitigates adverse effects of multipath propagation and delay spread on systems. That's why the OFDM scheme has widely been exploited for digital transmission technologies such as digital audio broadcasting (DAB), digital TV broadcasting, wireless local area network (WLAN), and wireless asynchronous transfer mode (WATM). Although hardware complexity was an obstacle to the wide use of the OFDM scheme, recent advances in digital signal processing technology including Fast Fourier Transform (FFT) and Inverse Fast Fourier Transform (IFFT) enable OFDM scheme to be easily implemented.

The OFDM scheme, although it is similar to conventional Frequency Division Multiplexing (FDM) scheme, is characterized in that it can obtain optimal transmission efficiency during high-speed data transmission by maintaining the orthogonality between subcarriers. Additionally, the OFDM scheme is characterized in that it has high frequency efficiency and is robust against multipath fading, thereby securing optimal transmission efficiency during high-speed data transmission. Further, because the OFDM scheme uses overlapping frequency spectrums, it has high frequency efficiency, is robust against frequency selective fading and multipath fading, reduces intersymbol interference (ISI) using a guard interval, enables design of an equalizer with a simple hardware structure, and is robust against impulse noises. Because of these and other advantages, the OFDM scheme is being actively applied to communication systems.

An orthogonal Frequency Division Multiple Access (OFDMA) scheme, reconfigures some subcarriers among all subcarriers as a subcarrier set, and allocates the subcarrier set to a particular access terminal (AT). OFDMA supports a Dynamic Resource Allocation (DRA) capable of dynamically allocating a subcarrier set to a particular access terminal according to a fading characteristic of a wireless transmission line.

FIG. 1 is an illustration of a configuration of a mobile communication system using a OFDMA system (hereinafter referred to as an “OFMDA mobile communication system”). The OFDMA mobile communication system, having a multicell configuration, i.e., having a cell 100 and a cell 150, is comprised of an access point (AP) 110 for managing the cell 100, an access point 160 for managing the cell 150, an access router (AR) 120 for controlling the access points 110 and 160, access terminals (ATs) 111 and 113 for receiving a service provided from the access point 110, access terminals 161 and 163 for receiving a service provided from the access point 160, and an access terminal 131 which is handed over to the access point 160 while receiving a service provided from the access point 110. It should be noted herein that the access router serves as a base station controller (BSC), and the access point serves as a base station (BS). Signal transmission/reception between the access points 110 and 160 and the access terminals 111, 113, 131, 161 and 163 is achieved using the OFMDA scheme.

In order to increase channel efficiency between an access point and access terminals located in the same cell, resources must be shared. In the OFDMA mobile communication system, the subcarriers are the typical resources that can be shared by a plurality of access terminals, The subcarriers are grouped into subcarrier sets. The entire transmission efficiency of the OFDMA mobile communication system depends upon how the subcarriers to the access terminals located in the cell are allocated. That is, scheduling for the subcarrier allocation always acts as an important factor for performance improvement of the OFDMA mobile communication system. However, because allocation of the subcarriers is determined according to channel states, active research is being pursued to develop a scheme for allocating subcarriers by accurately measuring a state of an allocated channel.

A description will now be made of a scheduling technique, or a technique for allocating the subcarriers.

Typically, the technique for allocating subcarriers is classified into Static Channel Allocation (SCA) and Dynamic Channel Allocation (DCA). SCA includes Static Subcarrier Assignment (SSA), Pseudo Static Assignment (PSA), and Simple Rotating Subcarrier Space Assignment (Simple RSSA), and DCA typically includes Fast Dynamic Channel Allocation (Fast DCA).

1) SSA

SSA, is one of the simplest subcarrier allocation techniques. SSA fixedly allocates a predetermined number of subcarriers to each the access terminal. That is, SSA fixedly allocates to a particular access terminal the predetermined number of subcarriers among all subcarriers for the OFDMA mobile communication system regardless channel states. Because SSA fixedly allocates the same number of subcarriers to all access terminals, it guarantees fairness of channel allocation but cannot guarantee the channel quality of subcarriers allocated to the access terminals.

2) PSA

PSA mutually exchanges, between access terminals, the fixed and predetermined number of the subcarriers allocated to the access terminals, and reallocates the exchanged subcarriers. That is, PSA, although it fixedly allocates the same number of subcarriers to all access terminals, can prevent deterioration in the channel quality of the access terminals by exchanging the allocated subcarriers between the access terminals. In conclusion, PSA allocates subcarriers having relatively higher channel quality to the access terminals, thereby increasing the entire transmission efficiency of the OFDMA mobile communication system.

3) Simple RSSA

Simple RSSA, a technique similar to PSA, allocates the same number, or the predetermined number of subcarriers to all of the access terminals. However, Simple RSSA, unlike PSA, preferentially allocates subcarriers having higher channel quality to access terminals having higher priority considering the priority, for example, QoS level. Although Simple RSSA can guarantee fairness in terms of the number of allocated subcarriers, it cannot guarantee the fairness of channel allocation because it allocates channels to the access terminals considering the QoS level.

4) Fast DCA

Fast DCA minimizes intracell interference or intercell interference, and allocates subcarriers having the best channel quality to access terminals considering the channel quality. That is, Fast DCA dynamically allocates subcarriers to access terminals according to the channel quality, thereby maximizing transmission efficiency of the OFDMA mobile communication system.

Additionally, research is being pursued to develop a scheme for efficiently allocating sets of subcarriers, i.e., subchannels, to access terminals considering the OFDMA characteristics so as to maximize user diversity. To efficiently allocate subchannels to access terminals, the use of channel quality information (CQI) being fed back to apply Adaptive Modulation and Coding (AMC) to the access terminals is not restricted only to a physical layer but extended to a medium access control (MAC) layer. In other words, the scheme for efficiently allocating subchannels to access terminals applies AMC based on CQI fed back from an access terminal (i.e., allocates a Modulation and Coding Scheme (MCS) level to a corresponding access terminal in the physical layer, and dynamically allocates subchannels using the CQI in the MAC layer). Therefore, in order to maximize transmission efficiency of the OFDMA mobile communication system, a scheme for determining in which layer to apply the AMC and DCA must also be taken into consideration.

FIG. 2 is a diagram illustrating a timing relation in the case where AMC and DCA are applied according to a decision made by an access point in a general OFDM mobile communication system., Referring to FIG. 2, an access terminal 200 transmits CQI to its access point 220 for a predetermined CQI transmission period 204 (in step 202). For example, the CQI is a signal-to-noise ratio (SNR). The access point 220 applies AMC and DCA to the access terminal 200 based on the CQI transmitted from the access terminal 200. That is, the access point 220 determines an MCS level to be applied to the access terminal 200 and allocates a subchannel to the access terminal 200 based on the CQI transmitted from the access terminal 200 (in step 222). In this case, the access point 220 selects the best subchannel for the access terminal 200 among idle subchannels based on the CQI transmitted from the access terminal 200. Although not illustrated in FIG. 2, the access point 220 transmits information on the allocated MCS level and subchannel to the access terminal 200. Then the access terminal 200 communicates with the access point 220 through the allocated subchannel according to the MCS level.

In the case where AMC and DCA are applied according to a decision made by the access point 220 as described above, because the access point 220 allocates an MCS level and a subchannel to be used by the access terminal 200, a back-haul delay time required in a network can be minimized and an MCS level and a subchannel can be correctly allocated considering a channel state of the access terminal 200.

However, as illustrated in FIG. 2, when the access terminal 200 performs a handover, the access point 220 must transmit to an access router 240 the information required to perform the handover of the access terminal 200 (in step 224). The access router 240 performs the handover process such that the access terminal 200 can be handed over from the access point 220 to another access point (not shown), based on the handover process information for the access terminal 200, transmitted from the access point 220 (in step 244), and transmits to the access point 220 the handover process information based on the handover process (in step 226). Then the access point 220 performs a handover-related procedure for the access terminal 200 using the handover process information transmitted from the access router 240 (in step 230).

In case of the handover, because the access point 220 performs the handover procedure for the access terminal 200 not by itself but in cooperation with the access router 240, a delay time occurs. The delay time includes a transmission time 242 required to transmit the handover process information from the access point 220 to the access router 240, and a transmission time 228 required to transmit when the handover process information to the access point 220. In conclusion, a delay time corresponding to the time required for the handover process occurs, and the occurrence of the delay time obstructs the fast handover process of the access terminal 200. When the access point 220 transmits a packet to the access router 240 to perform the handover, in some cases, the packet is overlappingly transmitted or lost during the handover process. Because the packet is lost occasionally, in the case where DCA and AMC are applied according to a decision made by the access point 220, as illustrated in FIG. 2, the transmission packets must include their unique serial numbers before being transmitted. However, the transmission of the serial numbers causes an undesirable reduction in transmission efficiency.

A process of applying AMC and DCA according to a decision made by an access point in an OFDM mobile communication system has been described so far with reference to FIG. 2. Next, with reference to FIG. 3, a description will be made of a process of applying AMC and DCA according to a decision made by an access router in an OFDM mobile communication system.

FIG. 3 is a diagram illustrating a timing relation in the case where AMC and DCA are applied according to a decision made by an access router in a general OFDM mobile communication system. Referring to FIG. 3, an access terminal 300 transmits CQI to its access point 320 during a predetermined CQI transmission period 304 (Step 302). For example, the CQI is an SNR. The access point 320 transmits to an access router 340 the CQI received from the access terminal 300 (in step 322). Then the access router 340 applies AMC and DCA to the access terminal 300 for an access router's processing time 344 and a scheduling time 346 based on the CQI from the access terminal 300 transmitted from the access point 320. That is, the access router 340 allocates an MCS level and a subchannel to be applied to the access terminal 300 based on the CQI from the access terminal 300.

In the case where AMC and DCA are applied according to a decision made by the access router 340 as described in connection with FIG. 3, a back-haul delay time in a network occurs. The back-haul delay time includes a CQI transmission time 342 from the access point 320 to the access router 340 and a transmission time 306 required when information on the MCS level and the subchannel allocated by the access router 340 is transmitted to the access point 320. As stated above, the back-haul delay time in a network does not consider the CQI from the access terminal 300 on a real-time basis, i.e., it does not correctly consider a channel state of the access terminal 300, thereby reducing its reliance upon MCS level and subchannel allocation by the access router 340.

### SUMMARY OF THE INVENTION

It is, therefore, an object of the present invention to provide a system and method for adaptively allocating resources to a plurality of access terminals according to channel states in an OFDMA mobile communication system.

It is another object of the present invention to provide a system and method for dynamically allocating resources considering the latest channel quality information in an OFDMA mobile communication system.

It is further another object of the present invention to provide a system and method for allocating a best frame cell/subchannel to an access terminal considering a weight of a frame cell in an OFDMA mobile communication system.

It is yet another object of the present invention to provide a system and method for allocating a best frame cell (FC) and subchannel (FC/subchannel) considering a quality-of-service (QoS) level in an OFDMA mobile communication system.

According to a first aspect of the present invention, there is provided a method for dynamically allocating a FC/subchannel in a mobile communication system which divides an entire frequency band into a plurality of sub-frequency bands and includes a plurality of FCs having a frequency domain and a time domain, occupied by a plurality of subchannels each of which is a set of a predetermined number of sub-frequency bands. In the method, an access point receives channel quality information (CQI) fed back from a plurality of access terminals on an FC-by-FC basis, and determines a modulation and coding scheme (MCS) which is to be applied to each of the access terminals based on the CQIs. If access terminals whose FCs/subchannels currently in use must be changed are detected from a plurality of the access terminals, the access point sends an FC/subchannel change request for the detected access terminals to an access router. The access router generates weights for all FCs in the access point, allocates an FC/subchannel set by selecting a predetermined number of FCs/subchannels considering the weights of the FCs for the access terminals corresponding to the received FC/subchannel change request, and transmits information on the allocated FC/subchannel set to the access point. The access point selects and allocates particular FC/subchannel among FCs/subchannels in the FC/subchannel set information received from the access router for the access terminals whose FCs/subchannels must be changed, based on CQIs which were last received from the access terminals whose FCs/subchannels must be changed.

According to a second aspect of the present invention, there is provided a method for dynamically allocating frame cell (FC)/subchannel by an access router in a mobile communication system which divides an entire frequency band into a plurality of sub-frequency bands and includes a plurality of FCs having a frequency domain and a time domain, occupied by a plurality of subchannels each of which is a set of a predetermined number of sub-frequency bands. The method includes the steps of receiving from an access point an FC/subchannel change request for access terminals whose FCs/subchannels must be changed; and generating weights for all FCs in the access point, allocating an FC/subchannel set by selecting a predetermined number of FCs/subchannels considering the weights of the FCs for access terminals corresponding to the received FC/subchannel change request, and transmitting information on the allocated FC/subchannel set to the access point.

According to a third aspect of the present invention, there is provided a method for dynamically allocating frame cell (FC)/subchannel by an access point in a mobile communication system which divides an entire frequency band into a plurality of sub-frequency bands and includes a plurality of FCs having a frequency domain and a time domain, occupied by a plurality of subchannels each of which is a set of a predetermined number of sub-frequency bands. The method includes the steps of receiving channel quality information (CQIs) transmitted from a plurality of access terminals on an FC-by-FC basis, determining a modulation and coding scheme (MCS) to be applied to each of the access terminals based on the CQIs, and if access terminals whose FCs/subchannels currently in use must be changed are detected from a plurality of the access terminals, sending an FC/subchannel change request for the detected access terminals to an access router; receiving, from the access router, information on FCs/subchannels changed in response to the FC/subchannel change request; and selecting and allocating particular FC/subchannel from among FCs/subchannels in FC/subchannel set information received from the access router for the access terminals whose FCs/subchannels must be changed, based on CQIs last received from the access terminals whose FCs/subchannels must be changed.

According to a fourth aspect of the present invention, there is provided a system for dynamically allocating frame cell FC/subchannel in a mobile communication system which divides an entire frequency band into a plurality of sub-frequency bands and includes a plurality of FCs having a frequency domain and a time domain, occupied by a plurality of subchannels each of which is a set of a predetermined number of sub-frequency bands. In the system, an access point receives channel quality information (CQIs) fed back from a plurality of access terminals on an FC-by-FC basis, determines a modulation and coding scheme (MCS) to be applied to each of the access terminals based on the CQIs, and sends an FC/subchannel change request for detected access terminals to an access router if the access terminals whose FCs/subchannels currently in use must be changed are detected from a plurality of the access terminals. If information on an FC/subchannel set including a predetermined number of FCs/subchannels, generated according to a predetermined control signal from the access router in response to the FC/subchannel change request, is received, the access point selects and allocates particular FC/subchannel among FCs/subchannels in the FC/subchannel set information for access terminals whose FCs/subchannels must be changed, based on the CQIs which were last received from the access terminals whose FCs/subchannels must be changed. The access router generates weights for all FCs in the access point, allocates an FC/subchannel set by selecting a predetermined number of FCs/subchannels considering the weights of the FCs for access terminals corresponding to the FC/subchannel change request received from the access point, and transmits information on the allocated FC/subchannel set to the access point.

### BRIEF DESCRIPTION OF THE DRAWINGS

The above and other objects, features and advantages of the present invention will become more apparent from the following detailed description when taken in conjunction with the accompanying drawings in which:

FIG. 1 is an illustration of a configuration of a general OFMDA mobile communication system;

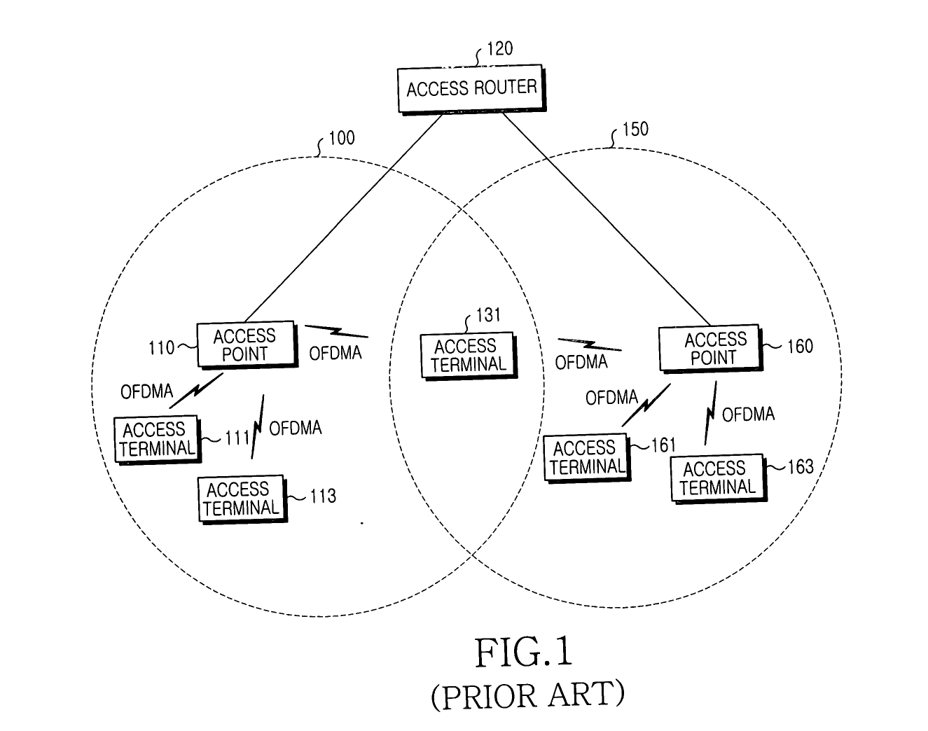

FIG. 2 is a diagram illustrating a timing relation in the case where AMC and DCA are applied according to a decision made by an access point in a general OFDM mobile communication system;

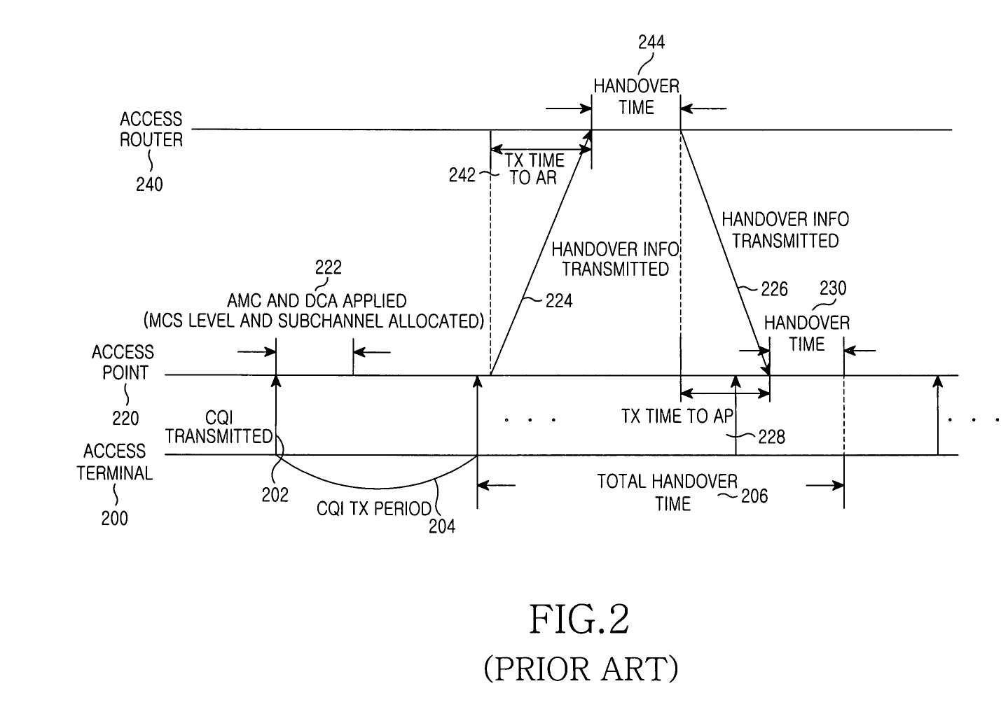

FIG. 3 is a diagram illustrating a timing relation in the case where AMC and DCA are applied according to a decision made by an access router in a general OFDM mobile communication system;

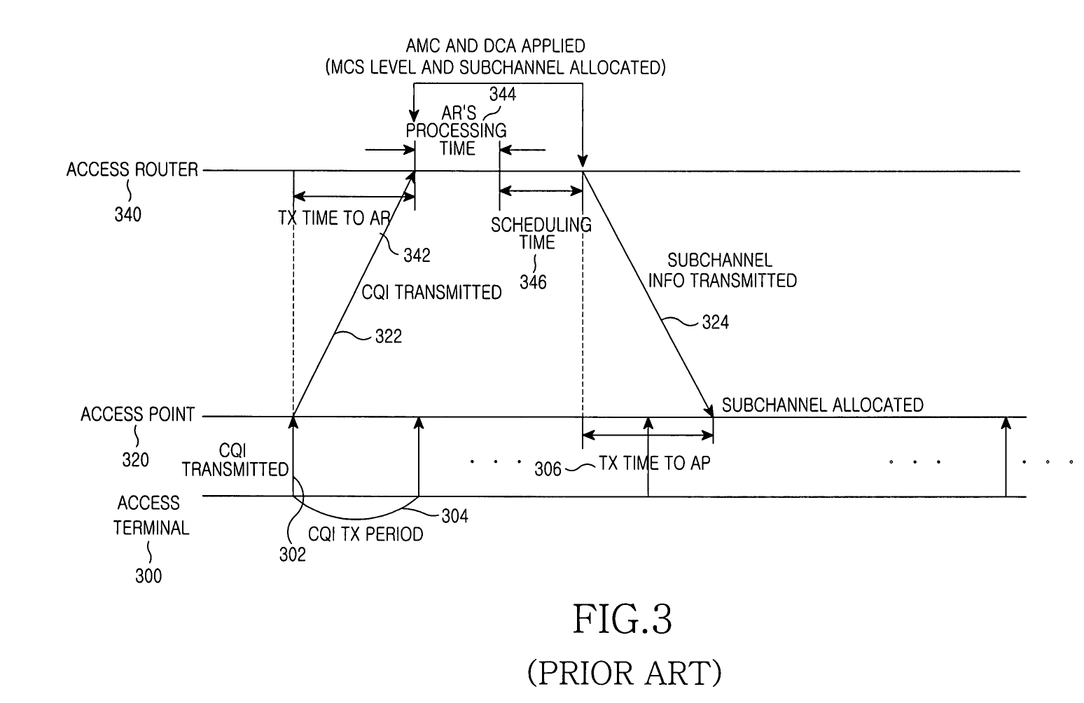

FIG. 4 is a chart illustrating a method for allocating time-frequency resources in an FH-OFCDMA communication system;

FIG. 5 is a diagram illustrating a timing relation during dynamic resource allocation in an FH-OFCDMA communication system according to an embodiment of the present invention;

FIG. 6 is a flow diagram schematically illustrating a dynamic resource allocation process in an FH-OFCDMA communication system according to an embodiment of the present invention;

FIG. 7 is a flowchart illustrating an operation of an access terminal according to an embodiment of the present invention;

FIG. 8 is a flowchart illustrating an operation of an access point according to an embodiment of the present invention;

FIG. 9 is a flowchart illustrating an operation of an access router according to an embodiment of the present invention;

FIG. 10 is a diagram illustrating subchannels allocated to access terminals for individual FCs according to an embodiment of the present invention;

FIG. 11 is a diagram illustrating a process of dynamically selecting FCs/subchannels in an access router according to an embodiment of the present invention;

FIG. 12 is a diagram illustrating weights of respective FCs according to an embodiment of the present invention;

FIG. 13 is a diagram illustrating a process of dynamically determining subchannels by an access point according to an embodiment of the present invention; and

FIG. 14 is a diagram illustrating access terminals reallocated to FCs according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

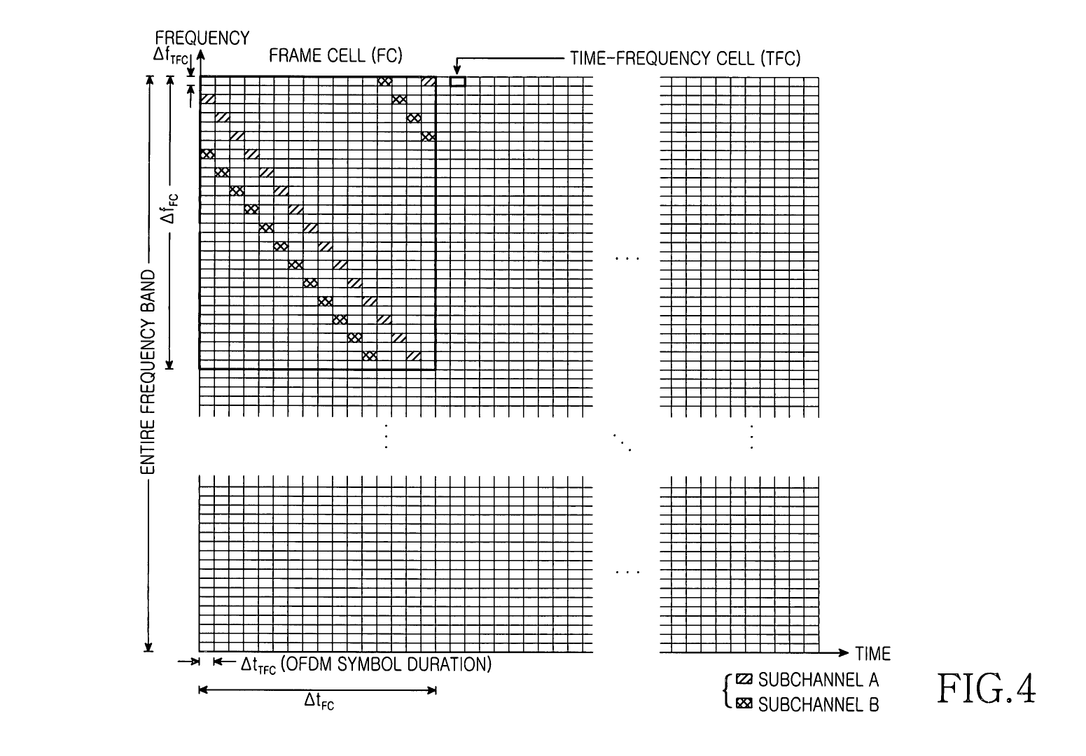

FIG. 4 is a chart which illustrates a method for allocating time-frequency resources in a communication system employing Frequency Hopping-Orthogonal Frequency Code Division Multiple Access (FH-OFCDMA). It should be noted that Orthogonal Frequency Division Multiplexing (OFDM) has a high spectrum efficiency because spectrums between subcarriers overlap each other while maintaining mutual orthogonality. OFDM uses an Inverse Fast Fourier Transform (IFFT) for modulation and a Fast Fourier Transform (FFT) for demodulation. As implementation of OFDM-based Multiple Access, there is Orthogonal Frequency Division Multiple Access (OFDMA) in which some of the subcarriers from among all of the subcarriers are allocated to a particular access terminal (AT). OFMDA does not need spreading sequences, and can dynamically change or reallocate a set of subcarriers allocated to a particular access terminal according to a fading characteristic of a wireless transmission channel. A scheme for dynamically reallocating a set of subcarriers allocated to a particular access terminal is referred to as “Dynamic Resource Allocation (DRA),” and Frequency Hopping (FH) is a typical example of DRA.

Unlike this, Multiple Access needing spreading sequences, is classified into Spreading-in-Time Domain and Spreading-in-Frequency Domain. Spreading-in-Time Domain is a technique for spreading an access terminal signal, or a user signal, in the time domain, and then mapping the spread signal to the subcarriers. Spreading-in-Frequency Domain is a technique for demultiplexing a user signal in a time domain, mapping the demultiplexed signal to the subcarriers, and distinguishing the user signal in a frequency domain using an orthogonal sequence. FH-OFCDMA is characterized in that it is not significantly effected by frequency selective fading through the CDMA and FH characteristics in addition to the characteristic of OFDM-based Multiple Access.

Referring to FIG. 4, a unit rectangle is comprised of a predetermined number of subcarriers, and is defined as a time-frequency cell (TFC) having the same duration as an OFDM symbol interval Δt_{TFC}. A plurality of subcarriers are allocated to the TFC. In a communication system employing FH-OFCDMA (hereinafter referred to as an “FH-OFCDMA communication system”), data corresponding to the subcarriers allocated to the TFC is processed by CDMA techniques, and thereafter, processed by OFDM using the subcarriers. The CDMA-based processing includes an operation of spreading data by a unique channelization code individually allocated to a subcarrier, and then scrambling the spread data by a predetermined scrambling code. A frame cell (FC) is defined in the time-frequency domain as having a bandwidth Δf_{FC} corresponding to a predetermined multiple (for example, 32 times) of the Δf_{TFC} and a frame duration Δt_{FC} corresponding to a predetermined multiple (for example, 16 times) of the Δt_{TFC}. The FH-OFCDMA communication system uses the FCs in order to prevent a measurement result on a wireless transmission line, i.e., channel quality information (CQI), from being frequently reported when Adaptive Modulation and Coding (AMC) is applied.

In FIG. 4, two different subchannels of a subchannel A and a subchannel B are illustrated in one FC. Here, the “subchannel” refers to a channel where a predetermined number of TFCs frequency-hop with the passage of time according to a frequency hopping pattern, before being transmitted. The number of TFCs constituting the subchannel and the frequency hopping pattern can be variably set according to various system variables, and it will be assumed that 16 TFCs constitutes one subchannel. The two different subchannels can be allocated to either different access terminals or the same access terminal. The subchannels hop at predetermined frequency intervals with the passage, of time. Thus, a subchannel which is individually allocated to each access terminal is dynamically changed according to a fading characteristic which varies with the passage of time. Although one fixed frequency hopping pattern is illustrated in FIG. 4, the frequency hopping pattern is variable.

If AMC is used, the access terminal performs a procedure for measuring a state of a wireless transmission line at predetermined periods and reporting the measurement result to an access point (AP). In response, the access point adjusts the modulation and coding schemes based on the wireless transmission channel's state information reported from the access terminal, and notifies the access terminal of the adjusted modulation and coding schemes. Thereafter, the access terminal transmits signals according to the modulation and coding schemes adjusted by the access point. In the FH-OFCDMA communication system, a report on the wireless transmission channel's state information is made on an FC-by-FC basis, thereby reducing a signaling load occurring due to the application of AMC. Of course, the FC can be adjusted according to the amount of overhead information generated due to the application of the AMC. For example, the FC is widened for a large amount of overhead information, and narrowed for a small amount of overhead information.

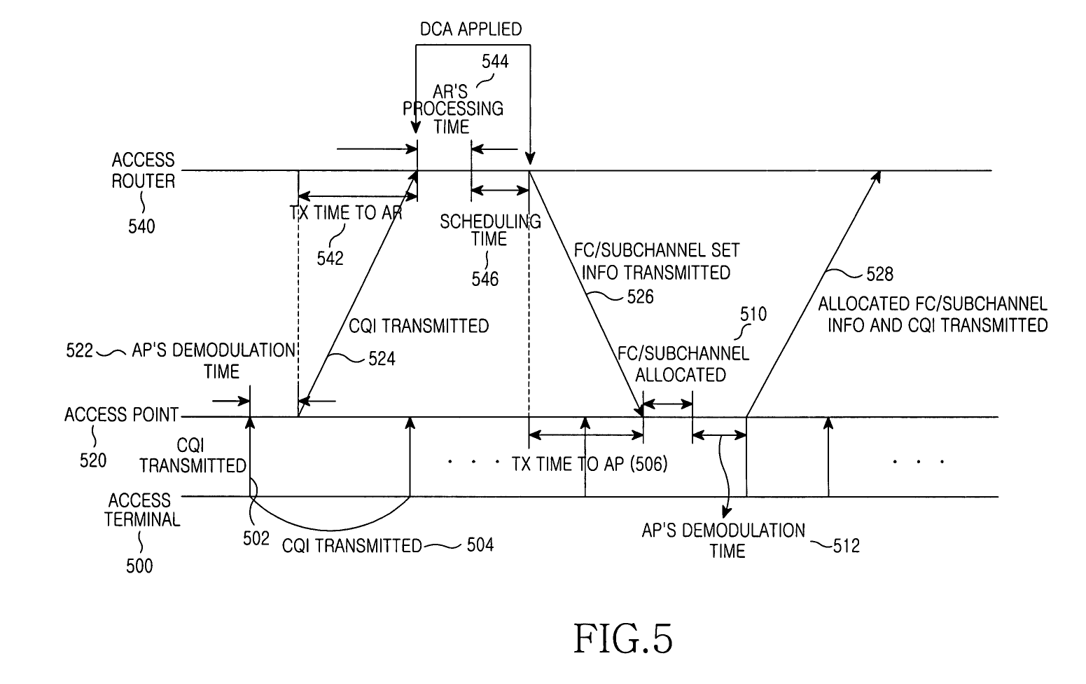

FIG. 5 is a diagram illustrating a timing relation in the case where AMC and DCA are applied to an FH-OFCDMA communication system according to an embodiment of the present invention. An access terminal 500 transmits CQI to its access point 520 during a predetermined CQI transmission period 504 (in step 502). Herein, the CQI can be, for example, a signal-to-noise ratio (SNR), and the access terminal 500 transmits the CQI on an FC-by-FC basis. The access terminal 500 transmits the CQI on an FC-by-FC basis to minimize signaling load and interference caused by the CQI transmission (as described in connection with FIG. 4). The access point 520 applies AMC based on the FC-based CQIs transmitted from the access terminal 500 and stores the AMC application result. That is, the access point 520 determines an MCS (Modulation and Coding Scheme) level for each of the FCs based on the FC-based CQIs transmitted from the access terminal 500, and stores the determined MCS levels for the FCs.

The access point 520 transmits the CQIs for the FCs to an access router (AR) 540 after storing the determined MCS levels for the FCs (in step 524). Here, a time required when the CQIs for the FCs are transmitted from the access point 520 to access router 540 is defined as a transmission time 542 to the access router. The access router 540 applies DCA to the access terminal 500 based on the CQIs for the FCs transmitted from the access point 520 for an access router's processing time 544 and a scheduling time 546. That is, the access router 540 sequentially orders (or arranges) the FCs in order of good channel state based on CQIs for the FCs from the access terminal 500. In the present invention, the channel states are divided into a ‘good’ channel state, a ‘normal’ channel state, and a ‘bad’ channel state. Therefore, a channel state for the FC becomes one of the three channel states.

Therefore, the access router 540 sequentially orders the FCs from a Good FC to a Bad FC based on CQIs for the FCs from the access terminal 500. Thereafter, the access router 540 selects a number of best FCs and subchannels for the channel state of the access terminal 500. Herein, the number of selected FCs and subchannels will be referred to as an “FC/subchannel set.” Further, it will be assumed that all of the subchannels in one FC have the same CQI, and in order to allocate a subchannel, because an FC including the subchannel to be allocated must be allocated together, it is represented that “FC and subchannel are allocated.” The access router 540 transmits to the access point 520 information related to an FC/subchannel set allocated to the access terminal 500 to the access point 520 (in step 526). Because the FH-OFCDMA communication system must take into consideration a plurality of access terminals, the access router 540 not only allocates an FC/subchannel set to the access terminal 500 according to channel states as described above, but also allocates the FC/subchannel set to an access terminal while also considering the terminal's relation with other access terminals receiving the same service as the access terminal 500 from the same access point 520. An operation of allocating an FC/subchannel set to access terminals by the access router 540 will be described below.

Information related to the FC/subchannel set for the access terminal 500 allocated by the access router 540 considering even an FC/subchannel set for other access terminals is sent to the access point 520, and the access point 520 compares CQIs for FCs in the FC/subchannel set which is received from the access router 540 with CQIs for the corresponding FCs last received from the access terminal 500. The access point 520 allocates to the access terminal 500 an FC and a subchannel having the best CQI from among the last received CQIs from among FCs in the FC/subchannel set as a result of the comparison (in step 510). Thereafter, the access point 520 transmits the FC-based CQIs received from the access terminal 500 and information on the allocated FC and subchannel to the access router 540 (in step 528).

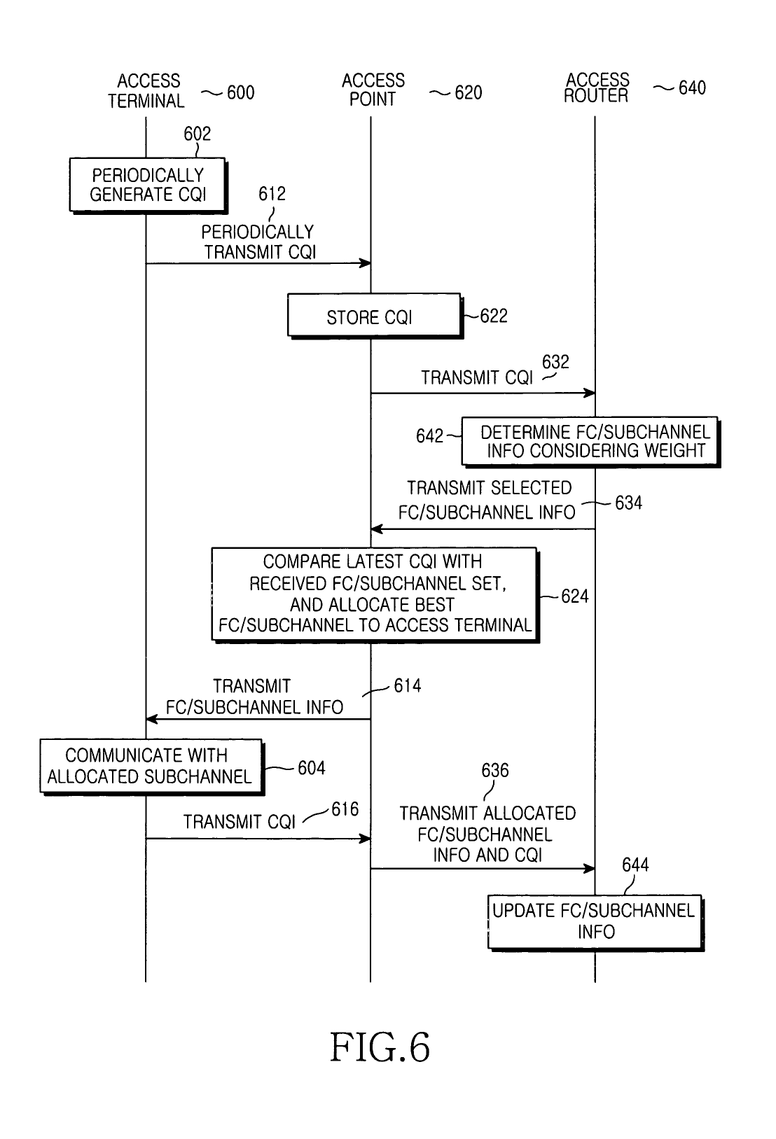

A timing relation in the case where AMC and DCA are applied in an FH-OFCDMA communication system has been described so far with reference to FIG. 5. Next, with reference to FIG. 6, a description will be made of a dynamic channel allocation process in an FH-OFCDMA communication system according to an embodiment of the present invention.

FIG. 6 is a flow diagram which schematically illustrates a dynamic channel allocation process in an FH-OFCDMA communication system according to an embodiment of the present invention. An access point 620 transmits pilot signals only through pilot subcarriers in predetermined positions. That is, an access terminal 600 previously knows the positions of subcarriers transmitted by the access point 620, and also knows pilot signals transmitted through the pilot subcarriers. The pilot signal has a predetermined sequence, and a sequence constituting the pilot signal, i.e., a pilot sequence, is prescribed between the access point and the access terminal.

In this way, the access terminal 600 acquires synchronization and generates CQI by receiving pilot signals from the access point 620 (in step 602). The access terminal 600 may have different service priorities, and a detailed description of the case where the service priority is taken into consideration will be made below with reference to accompanying drawings. The CQI is transmitted to the access point 620 on an FC-by-FC basis after a lapse of transmission period (in step 612). The access point 620 stores the FC-based CQI transmitted from the access terminal 600 (in step 622), and then transmits FC-based CQIs for respective access terminals to an access router 640 (in step 632). In the present invention, qualities of subchannels belonging to an individual FC are not separately classified. This means that subchannels belonging to an individual FC have the same qualities.

The access router 640 selects Good and Normal FCs and their corresponding subchannels considering individual weights of the sequential FCs (in step 642), and transmits information on the selected FCs/subchannel to the access point 620 (in step 634). The access point 620 compares the received FC/subchannel information with the latest CQI stored therein, selects the best FC to be allocated to each of the access terminals, and determines corresponding subchannels (in step 624). The access point 620 allocates the determined subchannels in the FCs to the respective access terminals, (in step 614) and the access terminal 600 communicates with the access point 620 with the allocated subchannels in the FCs (in step 604). The access point 620, after allocating FC/subchannel to the access terminal 600, transmits the information on the FC/subchannel allocated to the access terminal 600, to the access router 640 (Step 636). When the access point 620 changes a channel of the access terminal 600 or the access terminal 600 desires to change its channel in its own judgment, the access point 620 transmits the last stored CQI to the access router 640 (in step 636). The access router 640, receiving the information on the FC/subchannel allocated to the access terminal 600 and the CQI, updates the FC/subchannel information previously stored in its database (in step 644). The CQI is newly created after a transmission period lapses and transferred to the access point 620 by a predetermined number of frame cells (in step 616).

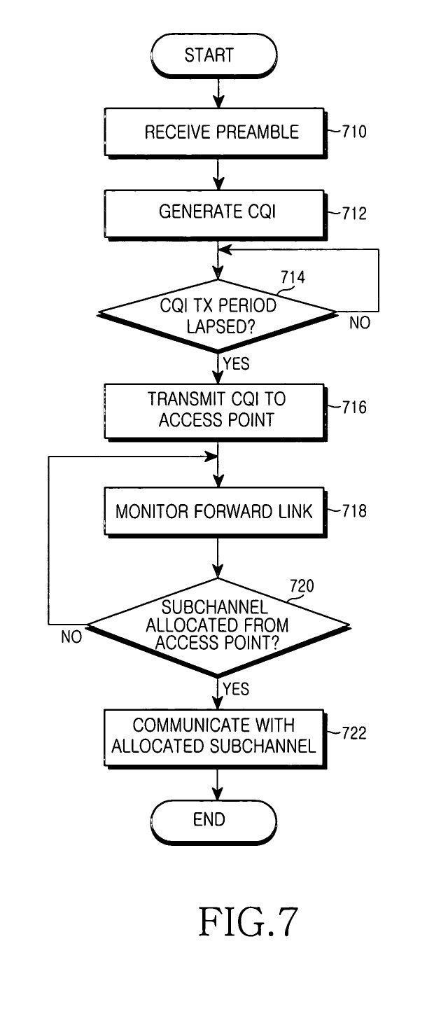

FIG. 7 is a flowchart illustrating an operation of an access terminal according to an embodiment of the present invention. In step 710, an access terminal receives a pilot signal (or a preamble signal) transmitted from an access point to acquire synchronization, and then proceeds to step 712. In step 712, the access terminal generates CQI, and then proceeds to step 714. In step 714, the access terminal determines whether a predetermined CQI transmission period has lapsed. If it is determined that the CQI transmission time has lapsed, the access terminal transmits the CQI to the access point in step 716. In the embodiment of the present invention, the CQI can be transmitted on an FC-by-FC basis. The CQI is not transmitted to the access point until the CQI transmission period has lapsed. The CQI transmitted by the access terminal becomes a criterion base on which the access terminal requests a change of its channel environment, determines that its own channel environment is bad, or the access point intends to change a channel environment of the access terminal by analyzing the CQI transmitted from the access terminal.

When one of the two conditions is satisfied, the access terminal desiring to change its channel environment continuously monitors a forward link for the access point in step 718, and then determines in step 720 whether information on an allocated subchannel in an FC is received from the access point. If it is determined that the information on the allocated subchannel is received, the access terminal communicates with the access point using the access channel in the FC in step 722. However, if the access terminal fails, in step 720, to receive the information on the allocated subchannel, the access terminal continuously monitors the forward link for the access point. Based on the subchannel information of the FC, an access router selects Good FCs and their corresponding subchannels considering individual weights of the FCs, and transmits the selected FCs/subchannels to the access point. The access point, receiving the FCs/subchannels, compares the received FCs/subchannels with the latest CQI stored therein to calculate the best FC/subchannel, and allocates the best FC/subchannel to the access terminal.

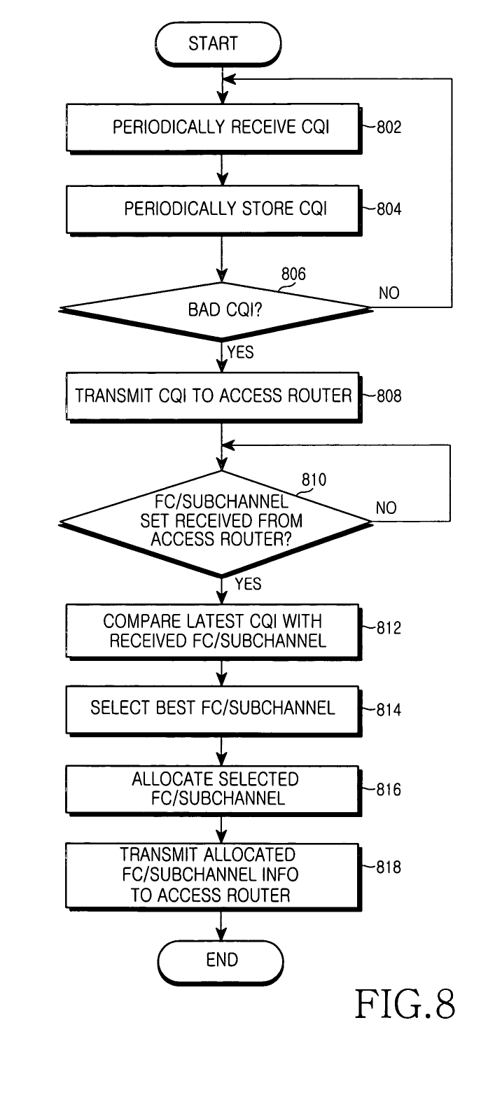

FIG. 8 is a flowchart illustrating an operation of an access point according to an embodiment of the present invention. Referring to FIG. 8, in step 802, an access point receives CQI transmitted from an access terminal, and then proceeds to step 804. In step 804, the access point stores the received CQI, and then proceeds to step 806. In step 806, the access point determines whether the received CQI represents Bad channel quality. If it is determined that the received CQI represents Bad channel quality, the access point proceeds to step 808 to allocate a new channel to the corresponding access terminal. In step 808, the access point transmits the CQI to an access router to change a channel state of the access terminal, and then proceeds to step 810. Thereafter, the access point waits until the access router sequentially selects some of subchannels in Good FCs considering individual weights of respective FCs and receives information on the selected FCs/subchannels. In step 810, the access point determines whether the information on the FCs/subchannels is received. If the information on the FCs/subchannels is received, the access point proceeds to step 812. In step 812, the access point compares the latest CQI transmitted by the access terminal with the channel information received from the access router. According to the comparison result, the access point selects in step 814 the best FCs/subchannels to be allocated to the access terminals, and then proceeds to step 816. In step 816, the access point allocates the determined FCs/subchannels to the access terminals, and then proceeds to step 818. In step 818, the access point transmits information on the FCs/subchannels allocated to the access terminals to the access router.

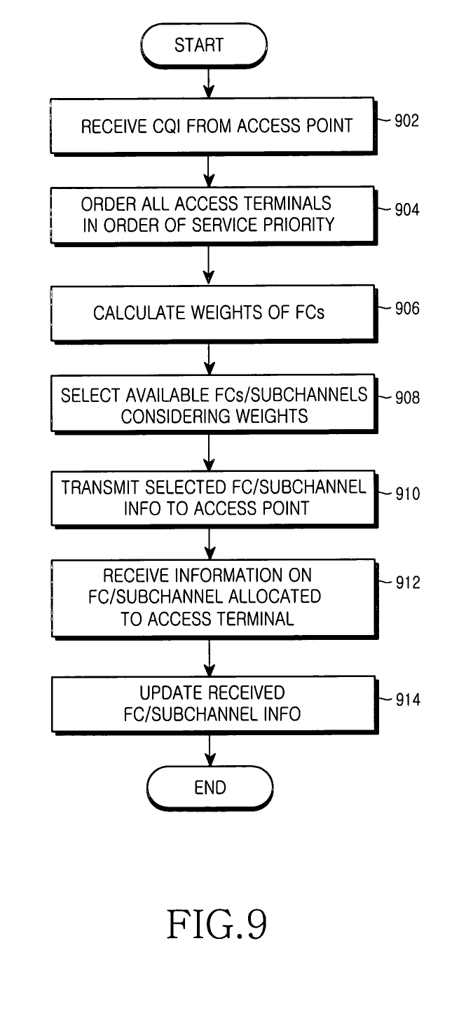

FIG. 9 is a flowchart illustrating an operation of an access router according to an embodiment of the present invention. Referring to FIG. 9, in step 902, an access router receives CQI that an access terminal periodically transmits, via an access point, and then proceeds to step 904. In step 904, the access router orders access terminals considering service priorities of all access terminals in the system, and then proceeds to step 906. In step 906, the access router calculates weights by adding the number of access terminals having Good FCs among access terminals that request channel allocation considering FCs of CQIs received from all access terminals, to the number of access terminals not requesting channel allocation for individual FCs allocated to the access terminals, and then proceeds to step 908. In step 908, the access router selects FCs/subchannels that can be allocated to the access terminals, and then proceeds to step 910. For example, if the calculated weights are 4 for a first FC, 2 for a second FC, and 3 for a third FC, then the access router selects FCs/subchannels having a low weight considering the weights such that even an access terminal having low service priority can be allocated a subchannel.

That is, the access router can preferentially select a subchannel in the second FC having a low weight for an access terminal having high service priority, and if the selected subchannel is allocated to an access terminal having low service priority, the access router compulsorily allocates the selected subchannel to an access terminal having high priority. This shows an example of allocating subchannels considering the service priority of the access terminals. After determining information on the FCs/subchannel to be allocated to the access terminals in this manner, the access router transmits the determined information to the access point in step 910, and then proceeds to step 912. In step 912, the access router receives information on the FCs/subchannels allocated to the access terminals by the access point, and then proceeds to step 914. In step 914, the access router updates its FC/subchannel information for the next allocation process based on the received allocation information.

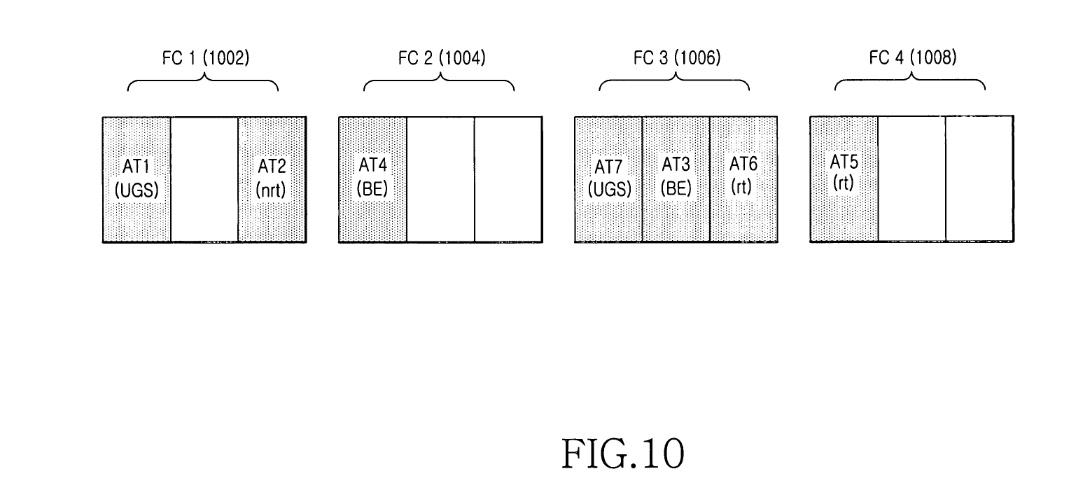

FIG. 10 is a diagram illustrating subchannels allocated to access terminals for individual FCs according to an embodiment of the present invention. Referring to FIG. 10, it is assumed that one frame cell has three subchannels having the same quality. Service priority of the access terminals can be classified into Unsolicited Guarantee Service (UGS), real time service (rt), non real time service (nrt), and Best Effort (BE). For example, in FIG. 10, an access terminal #1 (AT1) has service priority of UGS, an access terminal #2 (AT2) has service priority of ‘nrt’, an access terminal #3 (AT3) has service priority of BE, an access terminal #4 (AT4) has service priority of BE, an access terminal #5 (AT5) has service priority of ‘rt’, an access terminal #6 (AT6) has service priority of ‘rt’, and an access terminal #7 (AT7) has service priority of UGS.

In case of FC1 1002, the access terminal #1 AT1 in an UGS class is allocated to a first subchannel and the access terminal #2 AT2 in an nrt class is allocated to a third subchannel. In case of FC2 1004, the access terminal #4 AT4 in a BE class is allocated to a first subchannel. In case of FC3 1006, the access terminal #7 AT 7 in an UGS class is allocated to a first subchannel, the access terminal #3 AT3 in a BE class is allocated to a second subchannel, and the access terminal #6 AT 6 in an rt class is allocated to a third subchannel. In case of FC4 1008, the access terminal #5 AT 5 in an rt class is allocated to a first subchannel. It is assumed that among the access terminals, the access terminals #1, #3 and #5 (AT1, AT3 and AT5, respectively) need channel reallocation due to their bad channel states. If a channel reallocation request for the access terminals #1, #3 and #5 (AT1, AT3 and AT5, respectively) is received from an access point, an access router orders all of the 7 access terminals by performing step 904 of FIG. 9. Thereafter, in step 906 of FIG. 9, the access router calculates individual weights of the 4 FCs. The service priorities of the access terminals and the weights of FCs must be considered in determining FCs/subchannels to be allocated to the access terminals.

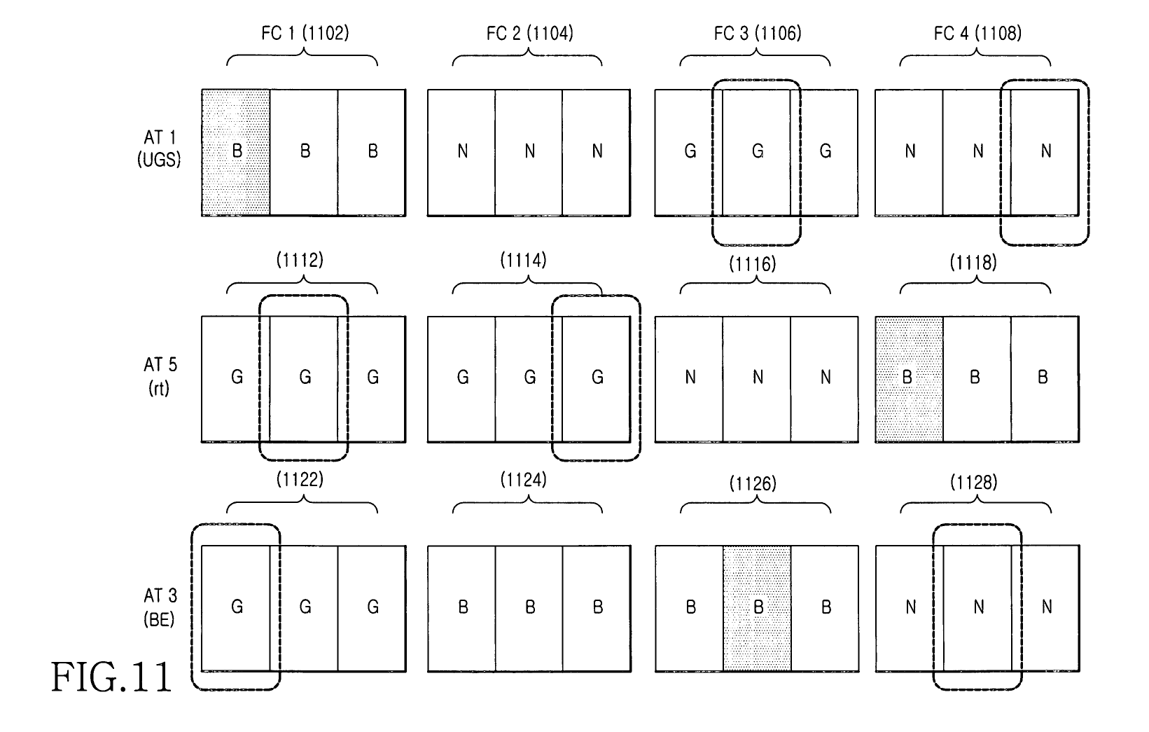

FIG. 11 is a diagram illustrating a process of dynamically selecting FCs/subchannels in an access router according to an embodiment of the present invention. FC1's of an access terminal #5 AT5 and an access terminal #3 AT3 have Good channel quality, and FC1 of an access terminal #1 AT1 has Bad channel quality. Therefore, a weight of the FC1 becomes 3 by adding the number, 2, of access terminals (AT3 and AT5) requesting channel reallocation to the number, 1, of access terminals not requesting channel allocation in (i.e., access terminal # 2 AT2) FC1 1002 of FIG. 10. In this method; a weight of FC2 becomes 2, a weight of FC3 becomes 3, and a weight of FC4 becomes 0.

After calculating individual weights of FCs in this way, the access router determines FCs/subchannels allocable to access routers considering the weights, and then transmits information on the determined FCs/subchannel to an access point. The service priorities of the access terminals and the weights of FCs must be considered in determining FCs/subchannels to be allocated to the access terminals. As illustrated in FIG. 11, the access terminals requesting channel reallocation are order in high service priority sequence of AT1, AT5 and AT3. If it is assumed that the access router determines a set of a total of 2 FCs/subchannels to be transmitted to the access point by selecting one subchannel from each FC, information on subchannels in FCs to be transmitted can be variably determined according to a system characteristic. In addition, the subchannels are determined only for a Good or Normal FC, and not for a Bad FC.

In case of FC1 1002 of FIG. 10, the access terminal #1 AT1 has the top service priority of UGS, and a first subchannel in FC1 1102 for the access terminal #1 has a bad channel state. Therefore, the access router preferentially selects a second subchannel in a Good FC3 1106 according to the FC's channel information transmitted by the access terminal #1 AT1, for the following reason. That is, because access terminals are allocated to all of the 3 subchannels in FC3 1106 of FIG. 10, the access router should compulsorily select subchannels for the access terminal #3 AT3 having the lowest service priority from among the 3 access terminals. The access terminal #3 AT3 turns over the allocated subchannel to the access terminal #1 AT1, and waits until it is reallocated a subchannel. For a second subchannel to be selected next, the access router compares FC2 1104 with FC4 1108. Because both FC2, 1004 and FC4 1006 are Normal FCs, their subchannels must be selected considering weights. A weight of the FC2 1004 is 2, and a weight of the FC4 1008 is 0. Therefore, the access router selects FC4 1108, and selects a third subchannel among subchannels in the FC4 1108 considering interchannel interference.

The access terminal #5 AT5 has the second-top service priority of ‘rt’, and a first subchannel in FC4 1118 for the access terminal #5 has a bad channel state. Therefore, the access router preferentially selects a third subchannel in FC2 1114 among a Good FC1 1112 and a Good FC2 1114 according to the FC's channel information transmitted by the access terminal #5 AT5, and then selects a second subchannel in the FC1 1112.

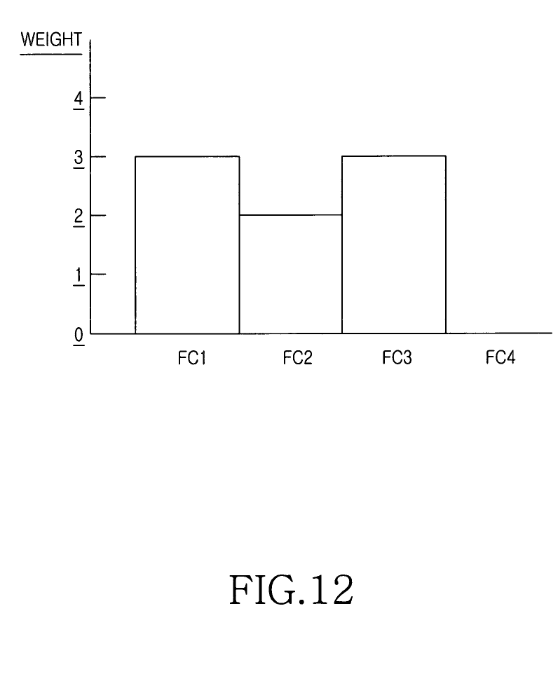

The access terminal #3 AT3 has the lowest service priority of ‘BE’ among the four service classes, and a second subchannel in FC3 1126 for the access terminal #3 AT3 has a bad channel state. Therefore, the access router preferentially selects a first subchannel in a Good FC1 1122 according to the FC's channel information transmitted by the access terminal #3 AT3. As a second subchannel to be determined next, the access router selects a second subchannel in FC4 1128 except a Bad FC2 1124 and a Bad FC3 1126. Information on the determined FCs/subchannels is transmitted to the access point. Weights of the FCs are illustrated in FIG. 12.

FIG. 12 is a diagram illustrating the weights of respective FCs according to an embodiment of the present invention. Referring to FIG. 12, a weight of FC1 is 3 because the number of access terminals not requesting channel reallocation is 1 and the number of access terminals reporting Good channel information of FC1 is 2. In the same manner, a weight of FC2 is 2, a weight of FC3 is 3, and a weight of FC4 is 0.

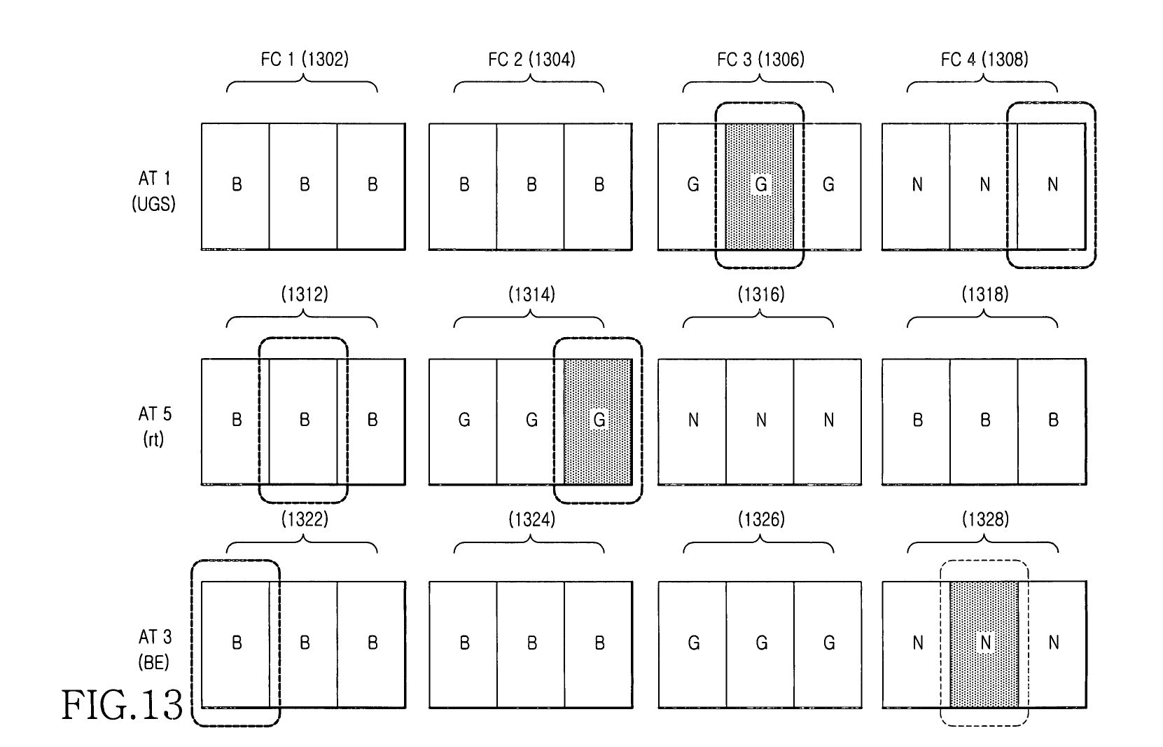

FIG. 13 is a diagram illustrating a process of determining subchannels by an access point according to an embodiment of the present invention. Referring to FIG. 13, the access point receives FC/subchannel allocation information from the access router. The access point compares the received information with the latest CQI received from an access terminal and selects the best FC/subchannel to be allocated to a particular access terminal, and allocates the selected FC/subchannel to the access terminal.

An access terminal #1, because it has the top service priority of UGS, is preferentially allocated a subchannel in an FC. Describing the latest CQI transmitted from the access terminal #1 to the access point, FC3 1306 has Good channel quality and FC4 1308 has Normal channel quality. Further, describing FC/subchannel information received at the access point from the access router, FC3 is a Good FC, and FC4 is a Normal FC. Therefore, the access point selects a second subchannel in FC3 1306 as a subchannel in the best FC to be allocated to the access terminal #1, and allocates the selected subchannel to the access terminal #1.

An access terminal #5 is secondly allocated a subchannel according to its service priority. Describing the latest CQI transmitted from the access terminal #5 to the access point, FC2 1314 has Good channel quality, FC3 1316 has Normal channel quality, and FC1 1312 and FC4 1318 both have Bad channel quality. Further, describing FC/subchannel information received at the access point from the access router, although FC1 and FC2 are both Good FC, the FC2 has higher priority than the FC1 when per-FC weight is taken into consideration. Therefore, the access point selects a third subchannel in FC2 1314 as a subchannel in the best FC to be allocated to the access terminal #5, and allocates the selected subchannel to the access terminal #5.

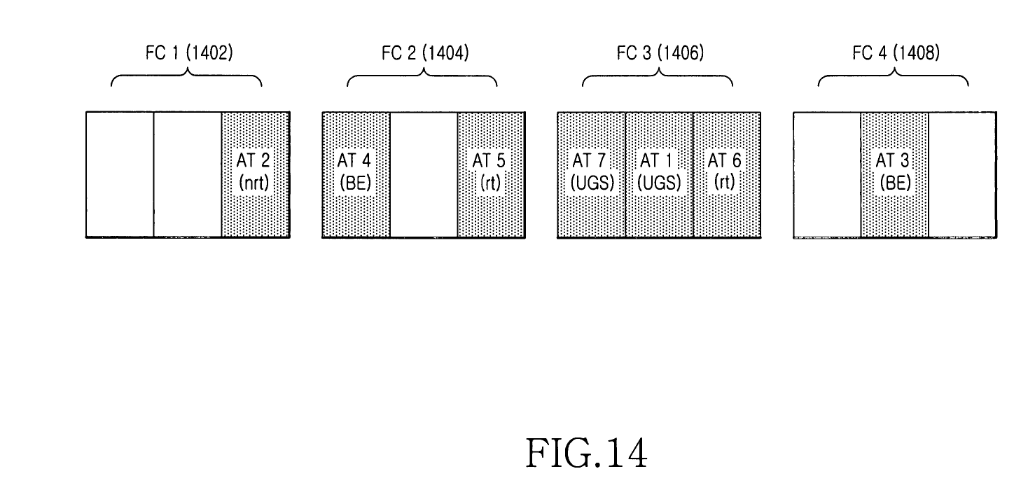

The access terminal #3 is finally allocated a subchannel as it has the lowest service priority of BE. Describing the latest CQI transmitted from the access terminal #3 to the access point, FC3 1326 has Good channel quality, FC4 1328 has Normal channel quality, and FC1 1322 and FC2 1324 both have Bad channel quality. Further, describing FC/subchannel information received at the access point from the access router, FC1 is a Good FC and FC4 is a Normal FC. Therefore, the access point selects a second subchannel in FC4 1328 as a subchannel with the best FC to be allocated to the access terminal #3, and allocates the selected subchannel to the access terminal #3. In this way, the access terminals are allocated to FCs as illustrated in FIG. 14.

FIG. 14 is a diagram illustrating access terminals reallocated to FCs according to an embodiment of the present invention. Referring to FIG. 14, in case of FC1 1402, an access terminal #2 is allocated to a third subchannel as it was. In case of FC2 1404, an access terminal #4 is allocated to a first subchannel, and an access terminal #5 is newly allocated to a third subchannel. In case of FC3 1406, an access terminal #7 is allocated to a first subchannel, an access terminal #1 is newly allocated to a second subchannel, and an access terminal #6 is allocated to a third subchannel as it was. In case of FC4 1408, an access terminal #3 is newly allocated to a second subchannel.

As described above, in the OFDMA mobile communication system, an access point compares information on a plurality of FCs/subchannels that an access router transmitted considering weights of respective FCs or QoSs of access terminals with the latest QCI received from the access terminals, thereby efficiently allocating channels to the access terminals. In addition, as weights are used, when access terminals have different QoS levels, it is possible to efficiently allocate resources to access terminals.

While the invention has been shown and described with reference to a certain preferred embodiment of dynamically allocating channels to access terminals considering service priority of the access terminals and weights of respective FCs, it will be understood by those skilled in the art that various changes in form and details may be made therein without departing from the spirit and scope of the invention as defined by the appended claims.

1. A method for dynamically allocating a frame cell (FC) and subchannel (FC/subchannel) in a wireless communication system which divides an entire frequency band into a plurality of sub-frequency bands and includes a plurality of FCs having a frequency domain and a time domain, occupied by a plurality of subchannels each of which is a set of a predetermined number of sub-frequency bands, the method comprising the steps of:
receiving, by an access point, channel quality information (CQIs) fed back from a plurality of access terminals on an FC-by-FC basis;
transmitting, by the access point, an FC/subchannel change request for at least one access terminal to an access router when FCs/subchannels currently used by the at least one access terminal need to be reallocated based on the CQIs;
generating, by the access router, weights for all FCs in the access point, allocating an FC/subchannel set by selecting a number of FCs/subchannels considering the weights of the FCs for the access terminals corresponding to the received FC/subchannel change request, and transmitting information on the allocated FC/subchannel set to the access point; and
selecting and allocating, by the access point, particular FC/subchannels from among FCs/subchannels in the FC/subchannel set information received from the access router for the access terminals whose FCs/subchannels must be changed, based on CQIs last received from the access terminals whose FCs/subchannels must be changed.

2. The method of claim 1, wherein the step of allocating by the access router an FC/subchannel set considering the weights of the FCs comprises the step of determining to allocate the FC/subchannel set considering weights determined by adding the number of access terminals requesting a channel change while transmitting a best subchannel in each of the FCs of CQIs received from the access terminals requesting the channel change, to the number of access of access terminals not requesting a channel change for the FCs.

3. The method of claim 2, further comprising the step of allocating, by the access router, a predetermined number of FCs/subchannels by applying weights separately calculated for the FCs/subchannels according to quality-of-service (QoS) levels of a plurality of access terminals.

4. The method of claim 1, further comprising the step of ordering, by the access router, the at least one access terminal according to quality-of-service (QoS) levels of the at least one access terminal.

5. A method for dynamically allocating a frame cell (FC) and subchannel (FC/subchannel) by an access router in a wireless communication system which divides an entire frequency band into a plurality of sub-frequency bands and includes a plurality of FCs having a frequency domain and a time domain, occupied by a plurality of subchannels each of which is a set of a predetermined number of sub-frequency bands, the method comprising the steps of:
receiving from an access point an FC/subchannel change request for access terminals whose FCs/subchannels must be changed; and
generating weights for all FCs in the access point, allocating an FC/subchannel set by selecting a predetermined number of FCs/subchannels considering the weights of the FCs for access terminals corresponding to the received FC/subchannel change request, and transmitting information on the allocated FC/subchannel set to the access point.

6. The method of claim 5, wherein the step of allocating an FC/subchannel set considering the weights of the FCs comprises the step of determining to allocate the FC/subchannel set considering weights determined by adding the number of access terminals requesting channel change while transmitting a best subchannel in each of the FCs of channel quality information (CQIs) received from the access terminals requesting channel change, to the number of access terminals not requesting channel change for the FCs.

7. The method of claim 6, further comprising the step of allocating a predetermined number of FCs/subchannels by applying the weights separately calculated for the FCs according to quality-of-service (QoS) levels of a plurality of access terminals.

8. The method of claim 5, further comprising the step of ordering at least one access terminal according to quality-of-service (QoS) levels of the at least one access terminal.

9. A method for dynamically allocating a frame cell (FC) and subchannel (FC/subchannel) by an access point in a wireless communication system which divides an entire frequency band into a plurality of sub-frequency bands and includes a plurality of FCs having a frequency domain and a time domain, occupied by a plurality of subchannels each of which is a set of a predetermined number of sub-frequency bands, the method comprising the steps of:
receiving channel quality information (CQIs) fed back from a plurality of access terminals on an FC-by-FC basis, determining a modulation and coding scheme (MCS) to be applied to each of the access terminals based on the CQIs, and if access terminals whose FCs/subchannels currently in use must be changed are detected from a plurality of the access terminals, sending an FC/subchannel change request for the detected access terminals to an access router;
receiving, from the access router, information on FCs/subchannels changed in response to the FC/subchannel change request; and
selecting and allocating particular FC/subchannels from among FCs/subchannels in the FC/subchannel set information received from the access router for the access terminals whose FCs/subchannels must be changed, based on CQIs last received from the access terminals whose FCs/subchannels must be changed.

10. A system for dynamically allocating a frame cell (FC) and subchannel (FC/subchannel) in a wireless communication system which divides an entire frequency band into a plurality of sub-frequency bands and includes a plurality of FCs having a frequency domain and a time domain, occupied by a plurality of subchannels each of which is a set of a predetermined number of sub-frequency bands, the system comprising:
an access point for receiving channel quality information (CQIs) fed back from a plurality of access terminals on an FC-by-FC basis, transmitting an FC/subchannel change request for detected access terminals to an access router if the access terminals whose FCs/subchannels currently in use must be changed are detected from the plurality of the access terminals, and if information on an FC/subchannel set including a predetermined number of FCs/subchannels, generated according to a predetermined control signal from the access router in response to the FC/subchannel change request, is received, selecting and allocating particular FC/subchannels from among FCs/subchannels in the FC/subchannel set information for access terminals whose FCs/subchannels must be changed, based on the CQIs last received from the access terminals whose FCs/subchannels must be changed; and
the access router for generating weights for all FCs in the access point, allocating an FC/subchannel set by selecting a predetermined number of FCs/subchannels considering the weights of the FCs for access terminals corresponding to the FC/subchannel change request received from the access point, and transmitting information on the allocated FC/subchannel set to the access point.

11. The system of claim 10, wherein the access router determines to allocate the FC/subchannel set considering weights determined by adding the number of access terminals requesting channel change while transmitting a best subchannel in each of the FCs of CQIs received from the access terminals requesting channel change, to the number of access terminals not requesting channel change for the FCs.

12. The system of claim 11, wherein the access router allocates a predetermined number of FCs/subchannels by applying weights separately calculated for the FCs according to quality-of-service (QoS) levels of a plurality of access terminals.
